(19) United States
(12) Patent Application Publication
(10) Pub. No.: US 2024/0172888 A1
(43) Pub. Date: May 30, 2024

(54) Control Box for a Cooking Appliance and Cooking Appliance

(71) Applicant: Topinox Sarl, Wittenheim (FR)

(72) Inventors: Klaus GRUEHBAUM, Wittenheim (FR); Christoph STROBL, Wittenheim (FR); Michael PRINZING, Wittenheim (FR); Manuel ULMER, Wittenheim (FR); Sven Ole REICHMANN, Wittenheim (FR); Bernhard SEITER, Wittenheim (FR)

(21) Appl. No.: 18/525,369

(22) Filed: Nov. 30, 2023

(30) Foreign Application Priority Data
Nov. 30, 2022 (DE) 10 2022 131 723.4

(51) Int. Cl. A47J 36/38; B05B 1/14; B08B 9/093

(52) U.S. Cl. CPC A47J 36/38; B05B 1/14; B08B 9/093; B08B 2209/08

(57) ABSTRACT

A control box for a cooking appliance is described, having a housing in which at least one steam inlet, at least one water nozzle, a steam outlet, and at least one cleaning agent inlet. The cleaning agent inlet is arranged between the steam inlet and the steam outlet with respect to a flow path of the steam. A cooking appliance having a control box also is described.

### FIELD OF THE DISCLOSURE

The present disclosure relates to a control box for a cooking appliance, comprising at least one steam inlet, at least one water nozzle, and at least one steam outlet, and to a cooking appliance.

### BACKGROUND

A control box serves to discharge steam generated in a cooking chamber during a cooking process, such that as little steam as possible escapes at a vent pipe of a cooking appliance. To this end, the steam is guided inside the cooking appliance to the control box in which the steam is to condense. For condensing larger quantities of steam, water is supplied via the water nozzle in the control box. The condensate can then be led to a waste water line via a water outlet.

When viewed over a longer period of time, deposits may form in the control box, as greasy vapors also flow from the cooking chamber into the control box. These deposits may impair the function of the control box, which is why regular cleaning is necessary.

However, as the control box is difficult to access, a regular cleaning involves great effort. Especially deposits on the ceiling of the control box are difficult to remove.

Thus, there is need for a control box which can be cleaned in a simple and efficient manner.

### SUMMARY

According to the present disclosure, this object is achieved by a control box for a cooking appliance, comprising a housing in which at least one steam inlet, at least one water nozzle, a steam outlet, and at least one cleaning agent inlet are present, the cleaning agent inlet being arranged between the steam inlet and the steam outlet with respect to a flow path of the steam. The cleaning agent inlet makes it particularly easy to introduce cleaning agent into the control box. The cleaning agent inlet which is arranged between the steam inlet and the steam outlet with respect to a flow path of the steam allows cleaning agent to be distributed particularly evenly in the control box, which results in an effective cleaning of the control box.

In particular, a cooking chamber atmosphere with a steam component and greasy vapors is guided through the steam inlet and the steam outlet.

The at least one cleaning agent inlet can be directed such that an outlet opening of the cleaning agent inlet in the control box is directed towards a ceiling of the control box. Deposits on the ceiling of the control box are usually particularly difficult to remove. Due to the orientation of the outlet opening towards the ceiling, cleaning agent is purposefully conveyed to the main soiling points in the control box and is atomized and distributed on the ceiling. The ceiling acts here like a baffle plate. This means that if the cleaning agent is sprayed onto the ceiling with a certain pressure, a particularly good distribution of the cleaning agent is achieved.

Alternatively or additionally, an outlet opening of the cleaning agent inlet in the control box can be directed to a side wall of the control box, a deflecting member configured to deflect a cleaning agent flow exiting the outlet opening towards the ceiling being present at the outlet opening. This permits a flexible positioning of the cleaning agent inlet while allowing at the same time the cleaning agent to be purposefully conveyed to the main soiling points in the control box.

The deflection is formed, for example, by a baffle plate arranged in the region of the outlet opening. In particular, the baffle plate is arranged such that a jet of cleaning agent hits the baffle plate after exiting the outlet opening. When hitting the baffle plate, the cleaning agent is at the same time atomized to some extent, which contributes to a uniform distribution of the cleaning agent.

According to one aspect, a plurality of cleaning agent inlets arranged on different walls of the control box may be provided. For example, at least one cleaning agent inlet may be present at the bottom, and at least one further cleaning agent inlet may be present on at least one side wall. In this way, the cleaning agent can be distributed over a particular large area and in a particularly uniform manner. The number and arrangement of the different cleaning agent inlets are in particular adapted to a shape and/or size of the control box. For example, the number and the position of the cleaning agent inlets may be selected such that an inner wall of the control box is wetted as completely and evenly as possible with cleaning agent.

The at least one cleaning agent inlet may be formed by a pipe which extends through a bottom or a side wall of the control box. Cleaning agent can be supplied particularly easily by means of a pipe. Furthermore, a cleaning agent line can be easily attached to a pipe.

For example, the pipe has a fanning structure at the outlet. The fanning structure may be formed by a curved or flattened section of the pipe. Alternatively or additionally, a baffle plate may be arranged at the outlet. The fanning structure serves to atomize the cleaning agent and distribute it over the largest possible area.

In its section arranged inside the control box, the pipe may have a plurality of distributing bores. The distributing bores also serve to distribute cleaning agent evenly and over a large area.

For example, the distributing bores are evenly distributed over a circumference of the pipe.

Starting from a side wall of the control box, the pipe for example extends over at least one third of a length of the control box, in particular up to a center of the control box. Starting from the center, the cleaning agent can be distributed sufficiently well even with only one cleaning agent inlet.

According to one aspect, a water outlet is provided, through which waste water is discharged from the control box. The waste water can run into the control box via the steam inlet. Therefore, the water outlet can be used both for draining the fresh water sprayed into the control box and for draining waste water out of the cooking chamber. This ensures a compact design when using the control box in a cooking appliance.

For example, the water outlet is located below the steam inlet, in particular concentrically or slightly offset therefrom. Waste water can thus flow as directly as possible to the outlet and thus contributes only slightly to a soiling of the control box.

According to one aspect, a grid structure which serves to shield high-frequency radiation is present in the control box, the grid structure being formed by a cast part in which a plurality of cleaning channels connected to a cleaning agent connection and opening at different points within the grid structure is formed. In this way, it is also possible to clean points which are difficult to access within the grid structure. The grid structure in particular serves as a microwave trap.

In an alternative embodiment, the grid structure may be formed by a pipe packet composed of square pipes which are welded together. This embodiment has the advantage that no tool mold is necessary, such that this embodiment is particularly suitable for small number of pieces.

As a further alternative, the grid structure may be formed by several, in particular edged sheet panels which are welded together.

For example, the grid structure has main channels which form in sections a flow path to the water outlet for the steam entering through the steam inlet, and which have a flow cross-section at least ten times larger than that of the cleaning channels. The steam entering through the steam inlet can thus also flow unhindered to the outlet even if a grid structure is present.

According to the present disclosure, the object is further achieved by a cooking appliance having a control box according to the present disclosure, wherein a line branches off from a cleaner pipe which in particular leads to a cooking chamber of the cooking appliance, and runs to the cleaning agent inlet. A length of the line required for supplying cleaning agent to the cleaning agent inlet is thus as short as possible.

Alternatively, a line can branch off from a fresh water connection and run to the cleaning agent inlet, so that fresh water can be used for cleaning.

### DESCRIPTION OF THE DRAWINGS

Further advantages and features will become apparent from the description below and from the accompanying drawings, to which reference is made and in which:

FIG. 1 schematically shows a cooking appliance according to the present disclosure having a control box according to the present disclosure,

FIG. 2 shows a control box according to the present disclosure in a further embodiment,

FIG. 3 shows a sub-assembly of the control box from FIG. 2,

FIG. 4 shows a further sub-assembly of the control box from FIG. 2,

FIG. 5 shows a control box in a further embodiment according to the present disclosure, to which a steam line is connected,

FIG. 6 shows a detailed view of a grid structure of the control box shown in FIG. 5,

FIG. 7 shows the control box from FIGS. 5 and 6 in a bottom view,

FIG. 8 schematically shows a control box in a further embodiment according to the present disclosure,

FIG. 9 schematically shows another control box according to the present disclosure, and

FIG. 10 schematically shows a further control box according to the present disclosure.

### DETAILED DESCRIPTION

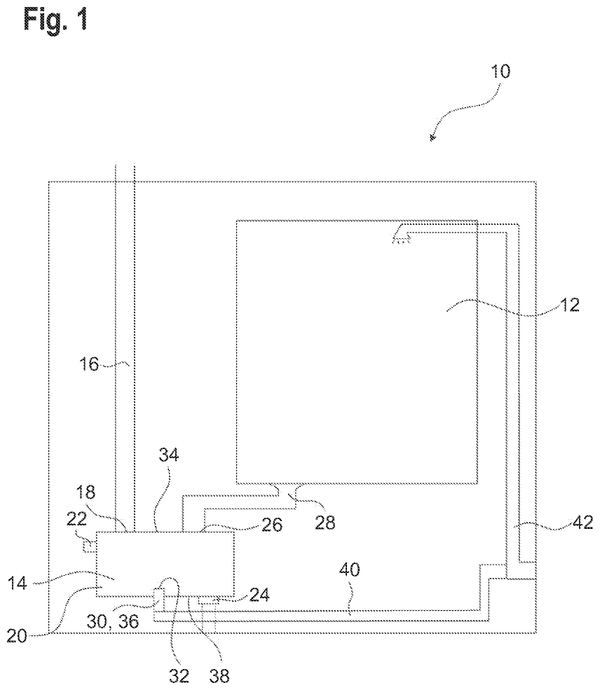

FIG. 1 schematically shows a cooking appliance 10 having a cooking chamber 12.

The cooking appliance 10 has a control box 14 which serves to condense steam from the cooking chamber 12.

For this purpose, a steam line 28 leads from the cooking chamber 12 to a steam inlet 26 which is formed in a housing 20 of the control box 14.

Non-condensed steam can escape from the control box 14 through a vent pipe 16 via a steam outlet 18 which is also formed in the housing 20, in particular on a ceiling 34 of the control box 14.

A water nozzle 22 is furthermore present in the housing 20 of the control box 14, via which water can be sprayed into the control box 14 to condense the steam.

A water outlet 24 via which the condensed steam and the sprayed water can flow off is furthermore present in the housing 20 of the control box 14.

The water outlet 24 is provided below the steam inlet 26. Waste water flowing, for example, through the steam inlet 26 into the control box 14, for example after cleaning of the cooking chamber 12, can thus flow off through the control box 14.

The control box 14 has a cleaning agent inlet 30 for cleaning purposes.

With respect to a flow path of the steam, the cleaning agent inlet 30 is arranged between the steam inlet 26 and the steam outlet 18.

The cleaning agent inlet 30 is directed such that an outlet opening 32 of the cleaning agent inlet 30 in the control box 14 is directed towards the ceiling 34 of the control box 14.

The cleaning agent inlet 30 is in particular formed by a pipe 36 which extends through a bottom 38 of the control box 14.

A line 40 branching off from a cleaner pipe 42 of the cooking appliance 10 runs to the cleaning agent inlet 30.

In an alternative embodiment which is not shown for the sake of simplicity, the line 40 branches off from a fresh water connection. This means that in this case, cleaning is carried out with fresh water.

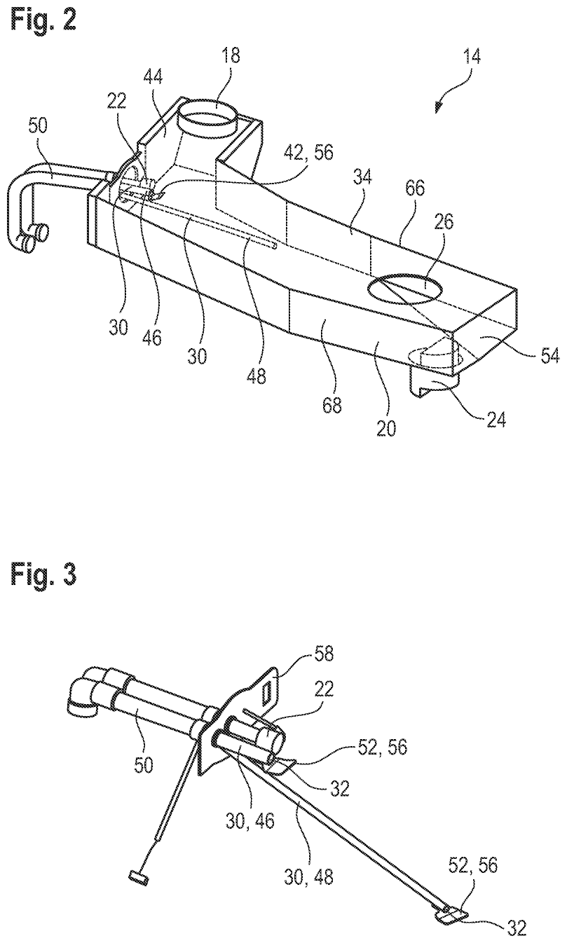

FIGS. 2 to 4 show in detail a control box 14 according to a further embodiment.

The same reference numerals will be used below for elements which have already been described in connection with FIG. 1, and reference is made in this respect to the above explanations.

In the control box 14 illustrated in FIGS. 2 to 4, two cleaning agent inlets 30 are provided which extend from a side wall 44 of the control box 14 into the control box 14.

The cleaning agent inlets 30 are each formed by a pipe 46, 48.

One of the pipes 48 branches off from the further pipe 46. Therefore, only a common supply pipe 50 is required. Alternatively, the pipes 46, 48 can extend completely separately from each other.

In the example embodiment, the pipes 46, 48 have different lengths, which allows the largest possible area of the control box 14 to be cleaned efficiently, as it is possible to spray cleaning agent at different points.

One of the pipes 46, 48 extends in particular over more than one third of the length of the control box 14, in particular up to a center of the control box 14.

The further pipe 46 extends over less than one third of the length of the control box 14, in particular less than one fifth of the length of the control box 14.

A fanning structure 52 is arranged at the outlet of each of the pipes 46, 48 (see FIG. 3).

The fanning structure 52 is a baffle plate, for example. If a cleaning agent exiting an outlet opening 32 of the pipes 46, 48 hits the baffle plate at a sufficiently high flow velocity, it is atomized, which ensures a uniform distribution of the cleaning agent.

In the embodiment illustrated in FIGS. 2 to 4, the outlet openings 32 of the cleaning agent inlets 30 or of the pipes 46, 48 are directed in the control box 14 towards a side wall 54 of the control box 14.

Therefore, the baffle plate also serves as a deflecting member 56 to deflect a flow of cleaning agent exiting the outlet openings 32 to the ceiling 34 of the control box 14.

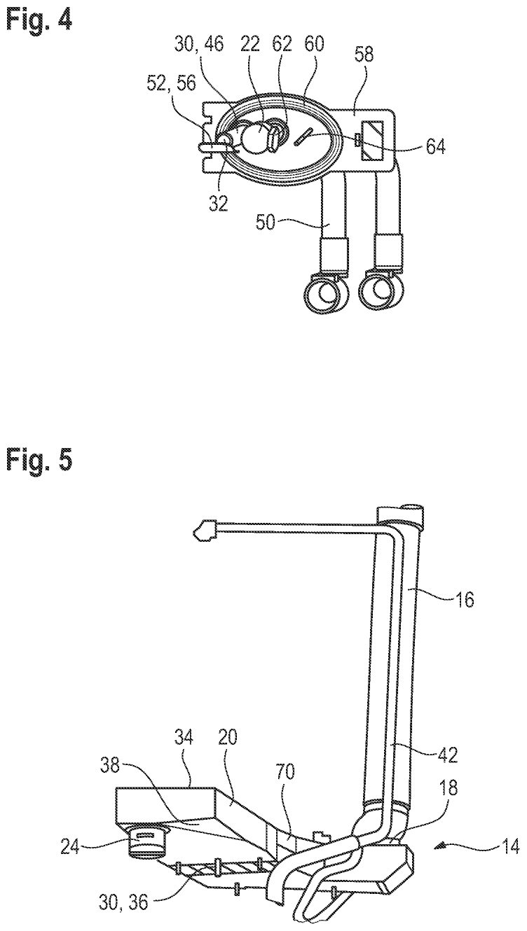

FIGS. 3 and 4 show a holder 58 on which the cleaning agent inlets 30 or the pipes 46, 48 are arranged, only one pipe 46 being shown in FIG. 4.

Furthermore, the water nozzle 22 is mounted on the holder 58.

The holder 58 can be attached to the side wall 44.

A seal 60 is arranged on the holder 58 (see FIG. 4) to prevent steam from escaping in an uncontrolled manner at the interface between the holder 58 and the side wall 44.

FIG. 4 shows an outlet opening 62 of the water nozzle 22.

The outlet opening 62 is aligned with a temperature sensor 64.

According to an alternative embodiment, which is not illustrated for the sake of simplicity, further cleaning agent inlets can be arranged on one or more of the remaining side walls 54, 66, 68.

FIG. 5 shows a control box 14 according to a further embodiment.

The embodiment shown in FIG. 5 differs from the embodiment described above in that a grid structure 70 is present in the control box 14.

The grid structure 70 forms a microwave trap which serves to shield high-frequency radiation.

The grid structure 70 includes main channels 72 which form in sections a flow path to the water outlet 24 for the steam entering through the steam inlet 26.

The grid structure 70 is formed by a cast part.

A plurality of cleaning channels 74 connected to a cleaning agent connection 76 and opening at different points inside the grid structure is formed in the cast part. Some of the cleaning channels 74 are shown purely schematically in FIG. 7.

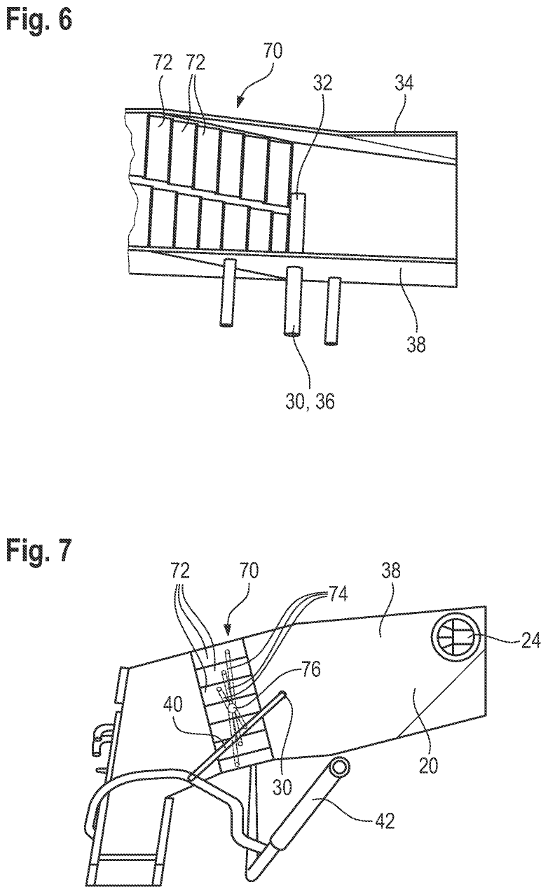

The control box 14 according to FIGS. 5 to 7 also has a cleaning agent inlet 30 the outlet opening 32 of which in the control box 14 is directed towards the ceiling 34 of the control box 14.

Such a cleaning agent inlet 30 may be provided alternatively or in addition to the cleaning agent inlets 30 in the control box 14 according to FIGS. 2 to 4.

It is furthermore conceivable that a cleaning agent inlet 30 is directed towards the grid structure 70, so that the cleaning agent inlet 30 contributes to the cleaning of the grid structure 70. In a further embodiment, which is not shown for the sake of simplicity, the grid structure 70 is formed by a pipe packet composed of square pipes welded together, or by several, in particular edged sheet panels which are welded together. In this case, the grid structure 70 is cleaned by means of a cleaning agent inlet 30 which is arranged and directed such that it can convey cleaning agent into the main channels 72 of the grid structure 70.

FIG. 7 shows the control box 14 in a bottom view. This view shows the line 40 which branches off from the cleaner pipe 42 and runs towards the cleaning agent inlet 76.

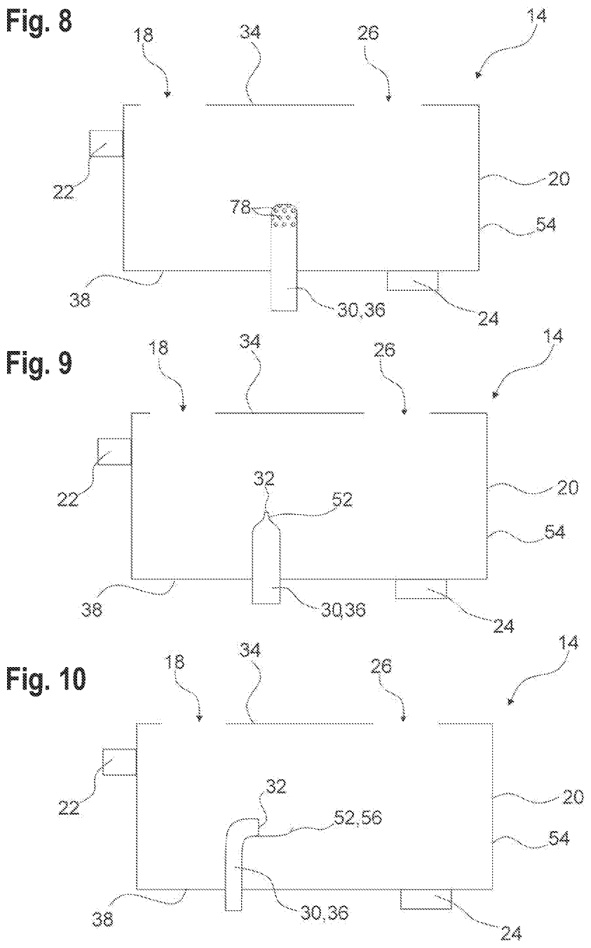

FIGS. 8 to 10 each illustrate further embodiments of the control box 14 which differ from each other in the shape of the cleaning agent inlet 30 respectively formed by a pipe 36.

The cleaning agent inlet 30 shown in FIG. 8 is configured as a pipe 36 having a plurality of distributing bores 78.

FIG. 9 shows a cleaning agent inlet 30 in which the pipe 36 which forms the cleaning agent inlet 30 is flattened. Due to the cross-section reduced by the flattened portion, a flow velocity at which the cleaning agent exits the pipe can be increased, which results in a better distribution of the cleaning agent. The flattened portion thus serves as a fanning structure 52.

According to the embodiment illustrated in FIG. 10, the pipe 36 forming the cleaning agent inlet 30 is bent. As shown in FIG. 10, a deflecting member 56 may be present depending on the orientation of the outlet opening 32.

In the embodiments shown in FIGS. 8 to 10, cleaning agent inlets can alternatively or additionally be arranged on the side walls.

Using the cleaning agent inlets 30 described above, a control box 14 can be cleaned particularly easily.

1. A control box for a cooking appliance, comprising a housing in which at least one steam inlet, at least one water nozzle, a steam outlet, and at least one cleaning agent inlet are present, the cleaning agent inlet being arranged between the steam inlet and the steam outlet with respect to a flow path of the steam.

2. The control box according to claim 1, wherein the at least one cleaning agent inlet is configured such that an outlet opening of the cleaning agent inlet in the control box is directed towards a ceiling of the control box, or in that the outlet opening of the cleaning agent inlet in the control box is directed towards a side wall of the control box, a deflecting member which is configured to deflect a cleaning agent flow exiting the outlet opening towards the ceiling being present at the outlet opening.

3. The control box according to claim 1, wherein a plurality of cleaning agent inlets arranged on different walls of the control box is provided.

4. The control box according to claim 1, wherein the at least one cleaning agent inlet is formed by a pipe which extends through a bottom or a side wall of the control box.

5. The control box according to claim 4, wherein the pipe has a fanning structure at the outlet.

6. The control box according to claim 4, wherein the pipe has a plurality of distributing bores in its section arranged inside the control box.

7. The control box according to claim 4, wherein the pipe extends from a side wall of the control box over at least one third of a length of the control box.

8. The control box according to claim 4, wherein the pipe extends from a side wall of the control box up to a center of the control box.

9. The control box according to claim 1, wherein a water outlet is provided, through which waste water is discharged from the control box.

10. The control box according to claim 1, wherein a grid structure which serves to shield high-frequency radiation is present in the control box, wherein the grid structure is formed by a cast part in which a plurality of cleaning channels connected to a cleaning agent connection and opening at different points within the grid structure is formed, or wherein the grid structure is formed by a pipe packet.

11. The control box according to claim 10, wherein the grid structure has main channels which form in sections a flow path to the water outlet for the steam entering through to the steam inlet and which have a flow cross-section at least ten times larger than that of the cleaning channels.

12. A cooking appliance having a control box as claimed in claim 1, wherein a line branches off from a cleaner pipe and runs towards the cleaning agent inlet.

13. The cooking appliance having a control box as claimed in claim 1, wherein a line branches off from a fresh water connection and runs towards the cleaning agent inlet.

14. The cooking appliance according to claim 12, wherein the at least one cleaning agent inlet is configured such that an outlet opening of the cleaning agent inlet in the control box is directed towards a ceiling of the control box, or in that the outlet opening of the cleaning agent inlet in the control box is directed towards a side wall of the control box, a deflecting member which is configured to deflect a cleaning agent flow exiting the outlet opening towards the ceiling being present at the outlet opening.

15. The cooking appliance according to claim 12, wherein a plurality of cleaning agent inlets arranged on different walls of the control box is provided.

16. The cooking appliance according to claim 12, wherein the at least one cleaning agent inlet is formed by a pipe which extends through a bottom or a side wall of the control box.

17. The cooking appliance according to claim 16, wherein the pipe has a fanning structure at the outlet.

18. The cooking appliance according to claim 16, wherein the pipe has a plurality of distributing bores in its section arranged inside the control box.

19. The cooking appliance according to claim 16, wherein the pipe extends from a side wall of the control box over at least one third of a length of the control box.

20. The cooking appliance according to claim 16, wherein the pipe extends from a side wall of the control box up to a center of the control box.
